(19) United States
(12) Patent Application Publication
(10) Pub. No.: US 2014/0178123 A1
(43) Pub. Date: Jun. 26, 2014

(54) RATCHET FOR A FRAME SYSTEM

(71) Applicant: Commercial Sewing, Inc., Torrington, CT (US)

(72) Inventors: Timothy C. Hamilton, Lenoir City, TN (US); Joseph Hamilton, III, Sweetwater, TN (US); Sam Dwello, Casselberry, FL (US)

(73) Assignee: Commercial Sewing, Inc., Torrington, CT (US)

(21) Appl. No.: 14/136,182

(22) Filed: Dec. 20, 2013

Related U.S. Application Data
(60) Provisional application No. 61/740,918, filed on Dec. 21, 2012.

(51) Int. Cl. E05D 7/00; F16C 11/10

(52) U.S. Cl. CPC E05D 7/0054; F16C 11/10
USPC 403/84; 16/235

(57) ABSTRACT

Disclosed is a ratchet for a frame system including at least a first frame section and a second frame section, the ratchet including a ratchet mount affixable to the first frame section; a ratchet hinge that is rotatably associated with said ratchet mount, said ratchet hinge being affixable to the second frame section; and a ratchet locking device configured to releasably lock said ratchet hinge at desirable angles relative to said ratchet mount. Further disclosed is a frame system with foldable features, the system including a first frame section rotatably associated with a second frame section via a ratchet, said ratchet allowing said first frame section and said second frame section to be foldable towards and away from each other, wherein said ratchet is configured to releasably lock said second frame section at desirable angles relative to said first frame section.

### CROSS REFERENCE TO RELATED APPLICATIONS

This application claims the benefit of U.S. Provisional Patent Application No. 61/740,918 filed on Dec. 21, 2012. The contents of U.S. Provisional Patent No. 61/740,918 are incorporated by reference herein in their entirety.

### FIELD

The disclosure relates generally to a ratchet for use in a frame system, and more particularly to a ratchet for use in a frame system with foldable or rotatable elements.

### BACKGROUND

Foldable frames are useful in various applications, such as those involving stowable canopy tops for recreation vehicles (particularly wake/arch towers and boat decks used on boating vessels). These frames are typically foldable between “open” and “closed” positions, with the open position requiring extendable support structures that hold the frame in an open position, and with the closed position requiring the support structure to be stowed. These support structures, such as support poles, are adequate at holding a frame in the open position, but can detract from aesthetic appeal and can be difficult to stow. In addition, support structures in the form of maneuverable poles may only provide for configurability into an open position and a closed position Indeed, such support structures typically offer very little option for configuring the frame in a position(s) “between” the open and closed position.

For at least the above reasons, a foldable frame with less cumbersome support structures and a greater selection of support positions would be desirable.

### SUMMARY

Disclosed is a ratchet for a frame system including at least a first frame section and a second frame section, the ratchet including a ratchet mount affixable to the first frame section; a ratchet hinge that is rotatably associated with said ratchet mount, said ratchet hinge being affixable to the second frame section; and a ratchet locking device configured to releasably lock said ratchet hinge at desirable angles relative to said ratchet mount.

Further disclosed is a frame system with foldable features, the system including a first frame section rotatably associated with a second frame section via a ratchet, said ratchet allowing said first frame section and said second frame section to be foldable towards and away from each other, wherein said ratchet is configured to releasably lock said second frame section at desirable angles relative to said first frame section.

Further disclosed is a ratchet for a frame system including at least a first frame section and a second frame section configurable between an open, separated position and closed, compacted position, the ratchet including a ratchet mount affixable to the first frame section; and a ratchet hinge that is rotatably associated with said ratchet mount, said ratchet hinge being affixable to the second frame section; wherein said ratchet mount and ratchet hinge are configured to support the frame system in the open, separated position absent assistance from one or more additional support devices.

Further disclosed is a frame system with foldable features, the system including a first frame section rotatably associated with a second frame section via a ratchet, said ratchet being configured to allow said second frame section to fold towards said first frame section into a closed position, and allow said second frame section to unfold away said first frame section into an open position, wherein said ratchet is configured to support said first frame section and said second frame section in said open position absent assistance from one or more additional support devices.

### BRIEF DESCRIPTION OF THE FIGURES

The accompanying drawings incorporated in and forming a part of the specification embodies several aspects of the present invention and, together with the description, serve to explain the principles of the invention. In the drawings:

FIG. 1 is a perspective view of a prior art frame in an open position;

FIG. 2 is a front elevation view of a prior art frame in a closed position;

FIG. 3 is a side elevation view of a foldable frame system in accordance with an exemplary embodiment;

FIG. 4 is a schematic side elevation view of a foldable frame system such as that shown in FIG. 3 in an open position;

FIG. 5 is a schematic side elevation view of a foldable frame system such as that shown in FIG. 3 in a closed position;

FIG. 6 is a schematic side elevation view of a foldable frame system such as that shown in FIG. 3 in an open position with an alternative frame configuration;

FIG. 7 is a side elevation view of a ratchet such as that shown in FIG. 3;

FIG. 8 is a side elevation view of a ratchet such as that shown in FIG. 3 in an open position;

FIG. 9 is a side elevation view of a ratchet such as that shown in FIG. 3 in a closed position;

FIG. 10 is a perspective view of a foldable frame system in accordance with another alternate embodiment; and

FIG. 11 is a perspective view of a foldable frame system in accordance with another alternate embodiment.

### DETAILED DESCRIPTION

The following disclosure will detail particular embodiments according to the present invention, which provides a ratchet for use in a frame system, and more particularly to a ratchet for use in a frame system with foldable or rotatable elements. Reference is now made to the drawings, wherein like reference numerals are used to refer to like elements throughout the disclosure.

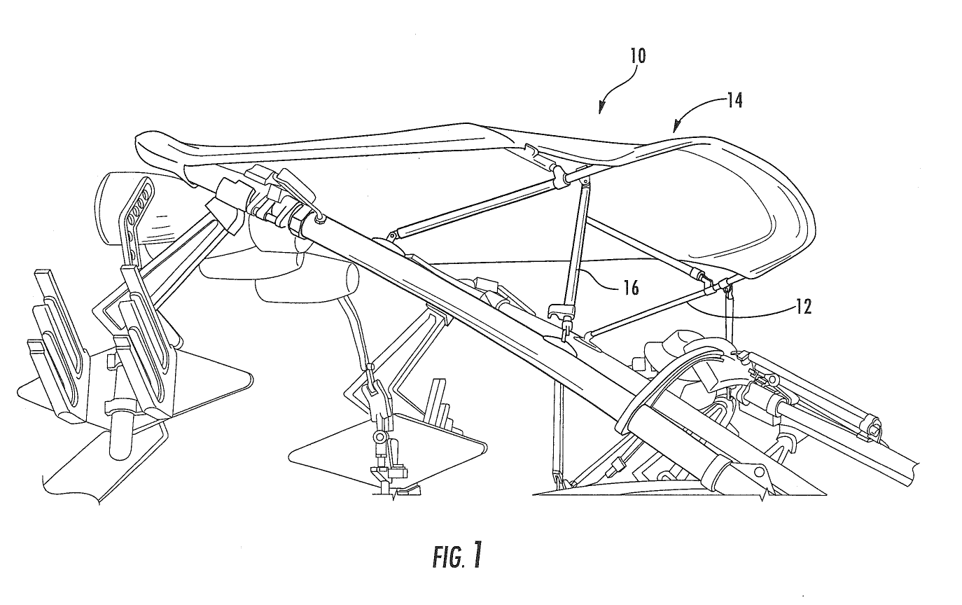

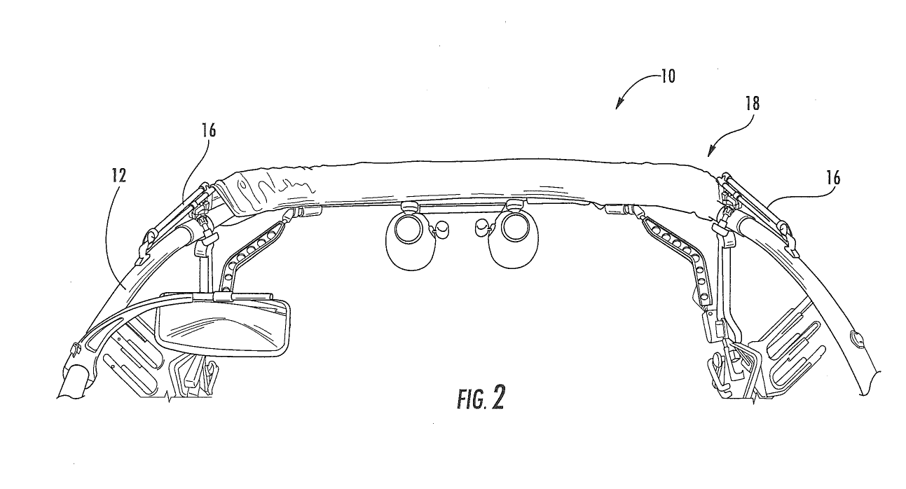

Referring to FIGS. 1 and 2, a prior art version of a boat tower 10 is shown. Referring to FIG. 1, the tower 10 includes a foldable frame 12 that is supported in an open position 14 by support poles 16, which act to tension and secure the top. As shown in FIG. 1, the poles 16 may create a cluttered appearance. Further, referring to FIG. 2, poles 16 must be stowed when the top/frame is in a stowed/closed position 18.

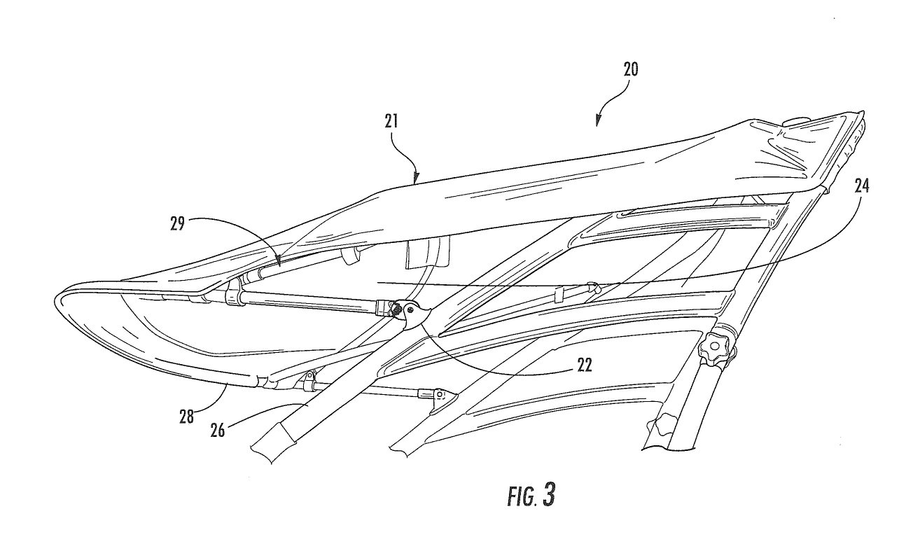

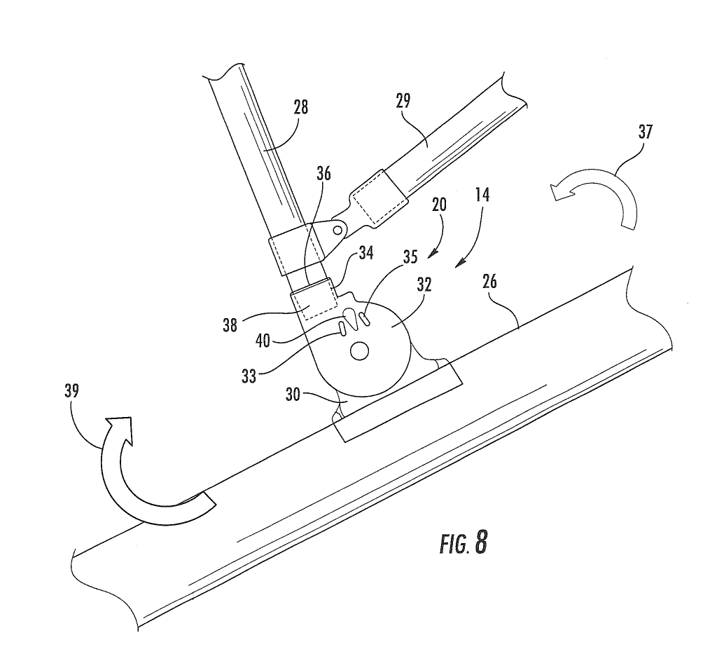

Referring now to FIGS. 3-9, a foldable frame system 20 including a ratchet 22 that eliminates the need for the above discussed support poles is shown. Similarly to FIGS. 1 and 2, the frame system 20 is shown in use with a boat tower. The wake/arch towers of FIGS. 3-6 include a foldable frame 24 with a first frame section 26 and a second frame section 28. These sections are rotatably associated via the ratchet 22. A description of the ratchet 22 and frame system 20 follows below.

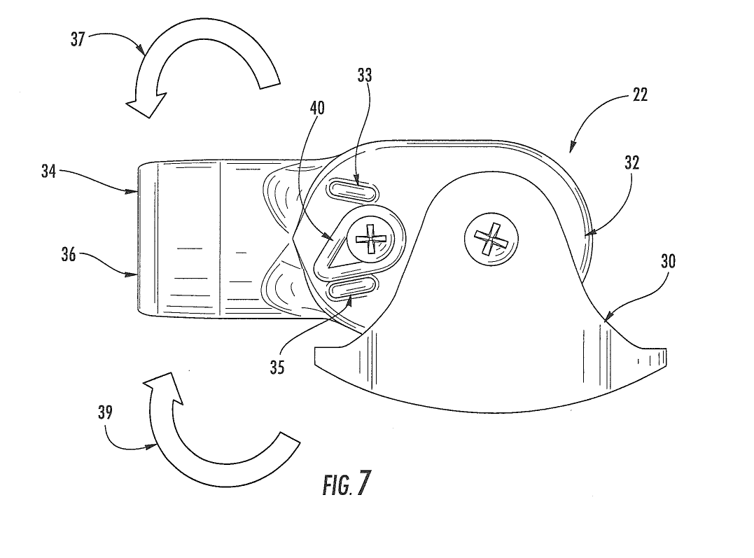

As is shown best in FIGS. 7-9, the ratchet 22 includes a ratchet mount 30 and a ratchet hinge 32 that is rotatably associated with the ratchet mount 30. In an exemplary embodiment, the ratchet hinge 32 and ratchet mount 30 may utilize any ratcheting device, such as but not limited to a ratchet spline and pawl mechanism. The spline and pawl mechanism may be used in conjunction with a locking handle 40 to allow releasably locking rotation in a desired direction. Locking handle 40 may be moved between detents 33 and 35 to determine the selected direction of rotation between ratchet hinge 32 and ratchet mount 30, wherein the ratchet spline mechanism does not allow rotation in the non-selected direction. Detents 33 and 35 may be configured to limit rotation to a clockwise 39 or counterclockwise 37 direction contingent on the detent 33,35 selected by locking handle 40. Detents 33,35 may be configured to limit or lock rotation in either rotational direction 37 or 39.

For example, if detent 33 is selected by locking handle 40 to allow clockwise rotation 39 (and not allow counterclockwise rotation 37), ratchet hinge 32 may rotate relative to ratchet mount 30 freely in a clockwise direction 39, but would be rotationally locked from rotating in a counterclockwise rotation direction 37. If counterclockwise rotation 37 of ratchet hinge 32 relative to ratchet mount 30 is then desired, detent 35 may be selected by locking handle 40 to allow counterclockwise rotation 37 of ratchet hinge 32 relative to ratchet mount 30. When detent 35 is selected, ratchet hinge 32 would be rotationally locked from rotating in a clockwise rotation 39 direction relative to ratchet mount 30.

The ratchet mount 30 may include a concavity corresponding to the curvature of a mounting surface, such as the surface of first frame section 26, as shown in FIG. 3. The concavity of ratchet mount 30 assists in associating the mount 30 with a curved or tubular frame section, such as a wake/arch tower (or portion thereof). With the body of the first frame potion 26 nested within the concavity of the mount 30, the ratchet 22 may be affixed to the first frame section 26 via any known releasable or more permanent means for fixing, such as but not limited to frictional fitting, a locking mechanism, a threaded association, welding, adhesive, or thread and loop associations.

In addition, the ratchet hinge 32 includes a cavity section 34 that defines pole cavity 36 that is shaped for accepting an end 38 of the second frame section 28 (as shown in FIG. 3). Similarly to the first section 26, the ratchet 22 may be affixed to the second frame section 28 via any known releasable or more permanent means for fixing, such as but not limited to frictional fitting, a locking mechanism (such as a pin extending across and through the widths/diameters of both elements), a threaded association, welding, adhesive, or thread and loop associations.

Referring to FIGS. 3-9, in an exemplary embodiment, first frame portion 26, which may be a wake/arch tower, is associated with mount 32 of ratchet 22, while second frame portion 28 is associated with hinge 32 of ratchet 22. By respectively associating the first and second frame potions 26, 28 with the mount 30 and hinge 32 of the ratchet 22, the first and second frame potions 26, 28 are allowed to rotate relative to each other in a direction 37 or 39 selectable by locking handle 40 and detents 33,35.

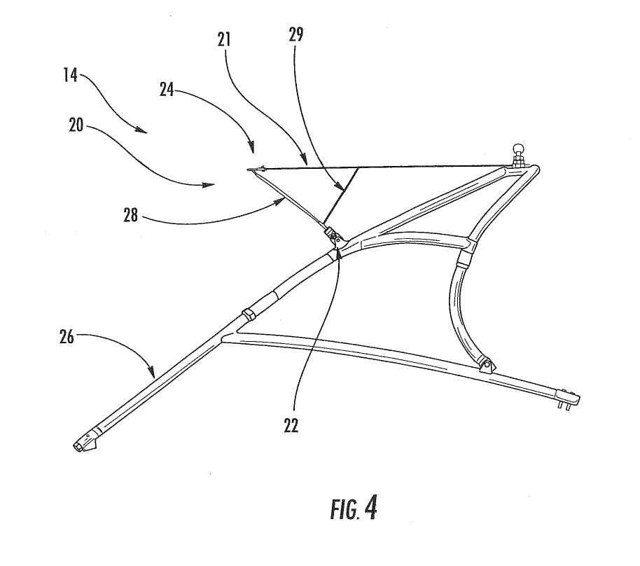

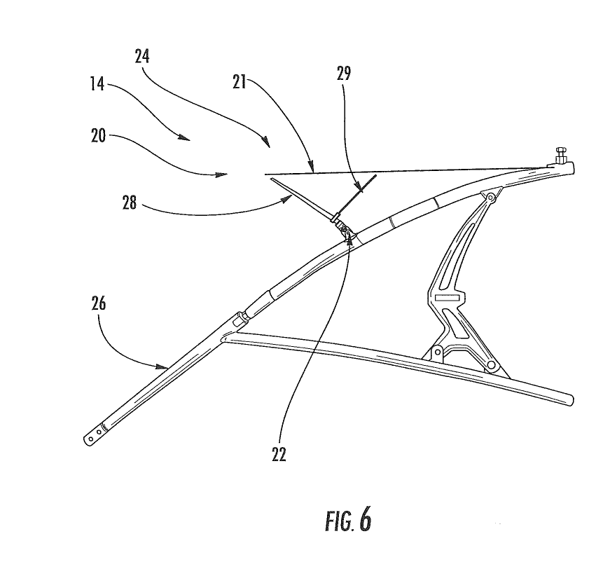

As best shown by FIGS. 4 and 6, in an exemplary embodiment, second frame portion 28 may be considered the front bow portion 28 of the frame system 20. Further, a center bow portion 29 may slide along front bow portion 28 to provide structure and support to top 21. Center bow portion 29 may selectably rotate along with front bow portion 28, but is not configured to provide support for the for the front bow portion 28.

This selectable rotation further allows the second frame section 28 and center bow portion 29 to fold towards and unfold away of the open and closed positions 14, 18. As previously discussed, the ratchet 22 is equipped with a locking handle 40 (associated with any known ratchet locking device internal to the ratchet 22, including a ratchet spline mechanism) that allows the second section 28 to be releasably locked in the open or separated position 14, when locking handle 40 selects the appropriate detent 33,35, as shown in FIGS. 4, 6, and 8. When the second section 28 is releasably locked in the open or separated position 14, the locking mechanism of ratchet 22 may support second section 28 absent any assistance from external support structures or devices. Referring to FIGS. 4 and 6, second section 28 may be configured to be locked into the open or separated position 14 wherein tension is applied to top 21, wherein top 21 may be made of canvas. The tension of top 21 may apply a force in a direction resisted by locked ratchet 22 (since locked ratchet 22 will only rotate in a direction to increase tension on top 21) to minimize movement of ratchet 22 and top 21.

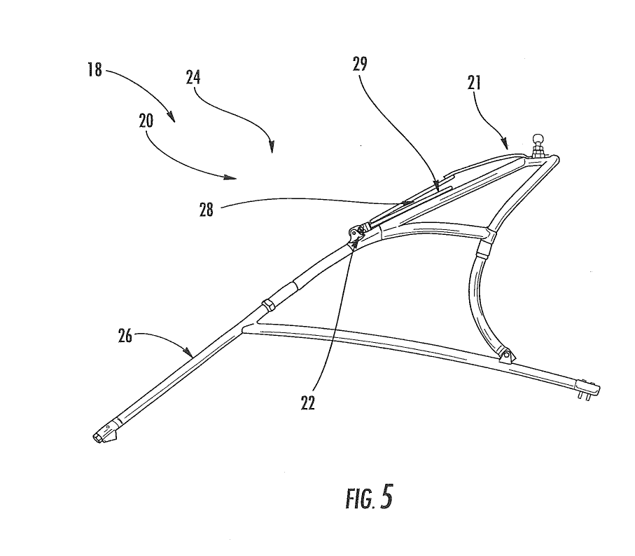

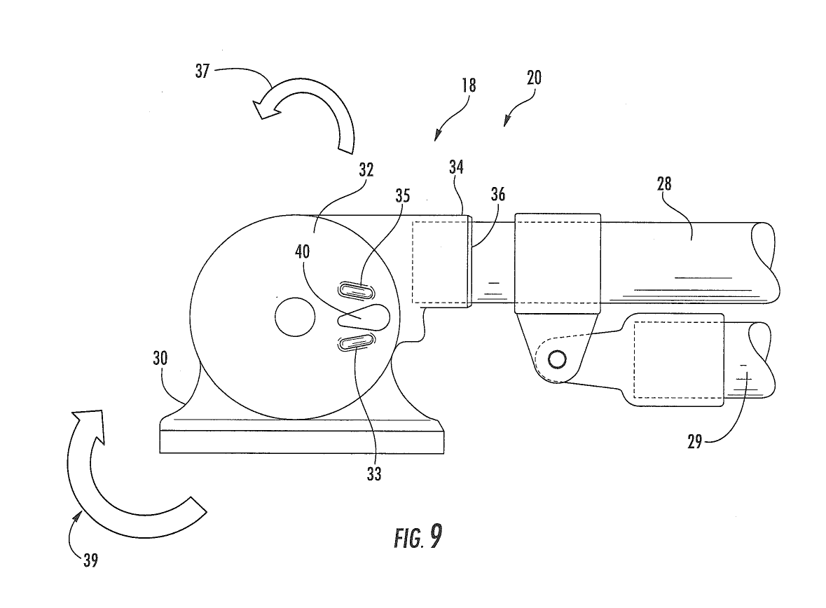

Referring to FIGS. 5 and 9, ratchet 22 allows the second section 26 to be releasably locked into the closed or compacted position 18 when locking handle 40 selects the opposite appropriate detent 33,35. As shown in FIG. 5, top 21 is effectively stowed when frame system 20 is in the closed or compacted position 18. When the second section 28 is releasably locked in the closed or compacted position 18, the locking mechanism of ratchet 22 may support second section 28 absent any assistance from external support structures or devices. Additionally, ratchet 22 allows for second section 26 to be releasably locked into any position therebetween or beyond the closed or compacted position 18 (e.g. approximately 180 degrees about the ratchet 22). In this manner, the cavity section 34 and therefore the second frame section 26 can be positioned and held at essentially any desirable angle within 180 degrees. Similarly, when the second section 28 is releasably locked or held in any desirable angle, the locking mechanism of ratchet 22 may support second section 28 absent any assistance from external support structures or devices.

In alternative embodiments, the disclosed foldable frame system 20 with ratchet 22 can be used with other recreational vehicles and/or storage compartments, such as but not limited to ATVs, motorized carts, canopies intended to create storage compartments, and cooler lids.

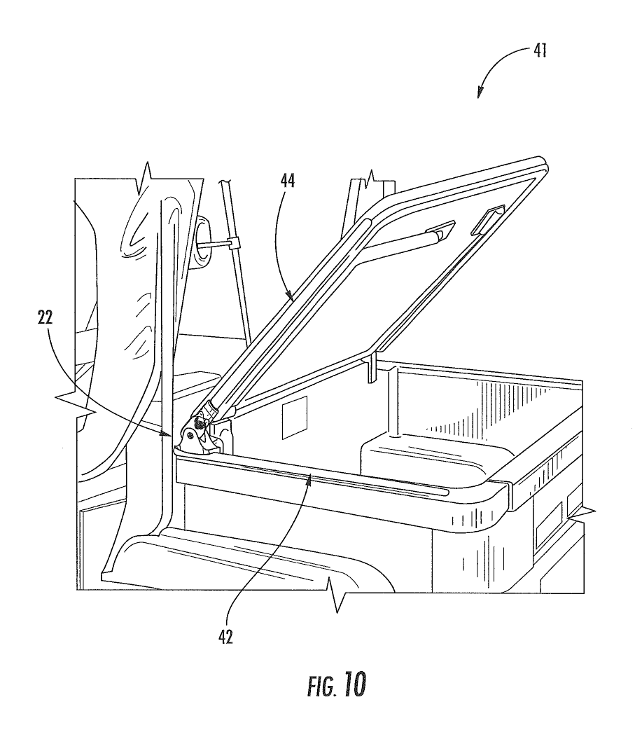

FIG. 10 illustrates foldable frame system 41 with ratchet 22 used to releasably lock a tonneau style lid 44 for a recreation vehicle in an open, closed, or any position therebetween. In this embodiment, first frame portion 42, which may be a body portion of a container or recreation vehicle, is associated with mount of ratchet 22, while second frame portion 44, which may be a tonneau style lid 44 is associated with hinge of ratchet 22. By respectively associating the first and second frame potions 42,44 with the mount and hinge of the ratchet 22, the first and second frame potions 42,44 are allowed to rotate relative to each other in a direction selectable by the locking handle.

This selectable rotation further allows the second frame section 44 to fold into and out of the open and closed positions. As previously discussed, the ratchet 22 is equipped with a locking handle 40 (associated with any known ratchet locking device internal to the ratchet 22) that allows the second section 44 to be releasably locked in the open position (as shown in FIG. 10). Further, ratchet 22 allows the second section 44 to be releasably locked into the closed position or any position therebetween or beyond the closed position (e.g. approximately 180 degrees about the ratchet 22). In this manner, the second frame section 44 can be positioned and held at essentially any desirable angle within 180 degrees.

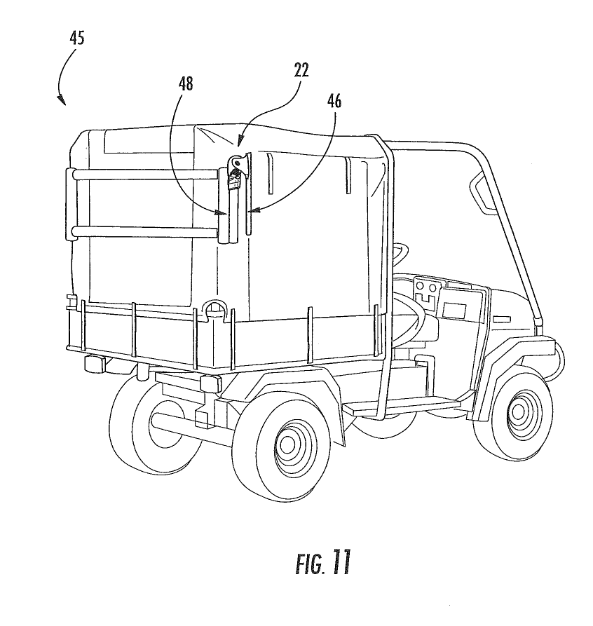

FIG. 11 illustrates foldable frame system 45 with ratchet 22 used to releasably lock a rear door 48 for a storage compartment in an open, closed, or any position therebetween. In this embodiment, first frame portion 46, which may be a body portion of a vehicle or a body portion of a storage compartment, is associated with mount of ratchet 22, while second frame portion 48, which may be a rear door 48 is associated with the hinge of ratchet 22. By respectively associating the first and second frame potions 46,48 with the mount and hinge of the ratchet 22, the first and second frame potions 46,48 are allowed to rotate relative to each other in a direction selectable by the locking handle.

This selectable rotation further allows the second frame section 48 to fold into and out of the open and closed positions. As previously discussed, the ratchet 22 is equipped with a locking handle (associated with any known ratchet locking device internal to the ratchet 22) that allows the second section 48 to be releasably locked in the open position. Further, ratchet 22 allows the second section 48 to be releasably locked into the closed position 18 (as shown in FIG. 11) or any position therebetween or beyond the closed position (e.g. approximately 180 degrees about the ratchet 22). In this manner, the second frame section 48 can be positioned and held at essentially any desirable angle within 180 degrees.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A ratchet for a frame system including at least a first frame section and a second frame section, the ratchet comprising:
a ratchet mount affixable to the first frame section;
a ratchet hinge that is rotatably associated with said ratchet mount, said ratchet hinge being affixable to the second frame section; and
a ratchet locking device configured to releasably lock said ratchet hinge at desirable angles relative to said ratchet mount.

2. The ratchet device of claim 1, wherein said ratchet hinge terminates at a cavity section defining a cavity, wherein said cavity is configured for accepting an end of the second frame section.

3. The ratchet device of claim 2, wherein the second frame section is affixable within said cavity via at least one of a frictional fitting, a locking mechanism, a threaded association, welding, adhesive, or thread and loop associations.

4. The ratchet device of claim 2, wherein said cavity section is extendable from said ratchet hinge at said desirable angles relative to said ratchet mount.

5. The ratchet device of claim 1, wherein said ratchet mount is affixable to a body of the first frame section at an area between ends thereof

6. The ratchet device of claim 5, wherein said ratchet mount includes a concavity corresponding to a shape of the body of the first frame section.

7. The ratchet device of claim 5, wherein said ratchet mounting is affixable to the body of the first frame section via at least one of a frictional fitting, a locking mechanism, a threaded association, welding, adhesive, or thread and loop associations.

8. The ratchet device of claim 5, wherein the first frame section is rotatably associated with the second frame section via said rotatable association between said ratchet mount and said ratchet hinge.

9. The ratchet device of claim 1, wherein said ratchet locking device is further configured to releasably lock the second frame section at desirable angled relative to said ratchet mount without additional frame support.

10. A frame system with foldable features, the system comprising:
a first frame section rotatably associated with a second frame section via a ratchet, said ratchet allowing said first frame section and said second frame section to be foldable towards and away from each other,
wherein said ratchet is configured to releasably lock said second frame section at desirable angles relative to said first frame section.

11. The frame system of claim 10, wherein at least one of said first frame section and said second frame section is associable with a recreation vehicle.

12. The frame system of claim 10, wherein at least one of said first frame section and said second frame section is associable with an openable storage compartment.

13. The frame system of claim 10, wherein said ratchet is further configured to releasably lock said second frame section at desirable angles relative to said first frame section without additional frame support.

14. A ratchet for a frame system including at least a first frame section and a second frame section configurable between an open, separated position and closed, compacted position, the ratchet comprising:
a ratchet mount affixable to the first frame section; and
a ratchet hinge that is rotatably associated with said ratchet mount, said ratchet hinge being affixable to the second frame section;
wherein said ratchet mount and ratchet hinge are configured to support the frame system in the open, separated position absent assistance from one or more additional support devices.

15. The ratchet device of claim 14, wherein at least one of said ratchet mount and said ratchet hinge includes a ratchet locking device configured to releasably lock said ratchet hinge at desirable angles relative to said ratchet mount absent assistance from said one or more additional support devices.

16. A frame system with foldable features, the system comprising:
a first frame section rotatably associated with a second frame section via a ratchet, said ratchet being configured to allow said second frame section to fold towards said first frame section into a closed position, and allow said second frame section to unfold away said first frame section into an open position,
wherein said ratchet is configured to support said first frame section and said second frame section in said open position absent assistance from one or more additional support devices.

17. The frame system of claim 16, wherein said ratchet is configured to releasably lock said second frame section in said open position at desirable angles relative to said first frame section absent assistance from said one or more additional support devices.
